(19) United States
(12) Patent Application Publication
(10) Pub. No.: US 2004/0083926 A1
(43) Pub. Date: May 6, 2004

(54) Dry mixture of embedding material or moulding material for metal casting, embedded or moulding material produced therefrom and the use of the same

(76) Inventors: Darina Mitkova, Oppenheim (DE); G?uuml;nter Schneider, Oestrich-Winkel (DE)

Correspondence Address: Steven L Oberholtzer, Brinks Hofer Gilson & Lione, P O Box 10396, Chicago, IL, 60610, US

(21) Appl. No.: 10/471,222

(22) PCT Filed: Apr. 4, 2002
(86) PCT No.: PCT/EP02/03732

(30) Foreign Application Priority Data
Apr. 4, 2001 (DE) 101 16 849.7

(51) Int. Cl. B28B 7/36; B28B 7/38; C04B 35/66

(52) U.S. Cl. 106/38.27; 106/640; 106/695; 106/718; 106/724; 106/725; 106/727; 106/728; 106/729; 106/737; 106/738

(57) ABSTRACT

A dry mix for producing embedding or molding compositions for metal casting processes such as the lost wax process containing a hydraulic binder component composed of sulfate-carrier-free ground portland clinker.

### TECHNICAL FIELD OF THE INVENTION

The invention relates to an embedding or molding composition dry mix for metal casting and embedding or molding compositions made therefrom and their use.

### BACKGROUND OF THE INVENTION

Particularly in precision lost wax processes for metal casting, the production of casting molds by introducing an embedding composition, a molding sand or the like into a mold so as to surround a model of the article to be molded is known. Furthermore, pressing a model into a molding composition or molding sand, then removing it and filling the corresponding impression with metal and subsequently removing the metal casting from the mold is also known.

The lost wax process, in particular, is employed for precision casting. In the lost wax process, a wax model is required for each casting to be produced. This wax model is coated with a liquid embedding composition, in particular an embedding composition comprising plaster of Paris. A solid container is subsequently built around the plaster-coated wax model and filled with a liquid embedding composition, in particular likewise comprising plaster of Paris. The dried casting composition is heated in a furnace until the wax in its interior melts, vaporizes and burns. A hollow body corresponding to the model has then been formed in the container.

Metal casting can subsequently be carrier out. For this purpose, the liquid metal alloy is poured into the hollow space in the casting composition. The casting is subsequently allowed to cool slowly. After solidification of the metal alloy, the surrounding, cured embedding composition is knocked off. The flaws due to air bubbles in the embedding composition and other unevennesses are removed by enchasing. In patinating, various chemicals are allowed to act on the metal surface to achieve, for example, an antique effect. As already mentioned, plaster molds are usually produced. Plaster molds contain up to 20% by mass of water of crystallization even after the wax has been burned out. For this reason, no hot metal may be poured into these molds at first. The plaster molds have to be dried and dewatered before metal casting. During this process, the phase transformations typical of calcium sulfate take place and can produce undesirable microstructural changes. These cause, in particular, shrinkage and thus the formation of shrinkage cracks and, after cooling, cooling cracks. The porosity and the gas permeability are also increased. In addition, particular metals (magnesium) can also cause chemical reactions in the plaster, which is also undesirable. A further disadvantage of the use of plaster of Paris is that these plaster compositions are usually produced by means of a vacuum stirring apparatus in order to degas the plaster composition prior to casting.

It is an object of the invention to provide an embedding or molding composition dry mix for embedding or molding compositions for metal casting, which makes possible a long controllable processing time, a high heat resistance and simple and rapid processing.

### SUMMARY OF THE INVENTION

In accordance with this invention, a dry mix for an embedding or molding composition for a metal casting process comprises a hydraulic binder component that includes a sulfate-carrier-free ground portland clinker.

In another aspect of this invention, an embedding or molding composition is formed from a dry mix that includes a hydraulic binder component composed of sulfate-carrier-free ground portland clinker and water.

### DETAILED DESCRIPTION OF INVENTION

According to the invention, a dry mix for an embedding or molding composition for metal casting comprises a sulfate-carrier-free hydraulic binder and, in particular, a superfine sulfate-carrier-free hydraulic binder. A preferred sulfate-carrier-free hydraulic binder is finely milled or superfine portland cement clinker. While embedding or molding compositions based on hydraulic binders such as portland cement give molds which are not thermally stable and do not suitably withstand the thermal shock on pouring in the liquid metal, it has surprisingly been found that an embedding or molding composition using a sulfate-carrier-free hydraulic binder, in particular using a sulfate-carrier-free milled portland cement clinker, achieves excellent heat resistance, a very good thermal shock resistance and a very good long-term heat resistance. In addition, an embedding or molding composition formed from a dry mix comprising the sulfate-carrier-free hydraulic binder used according to the invention is able to be finely adjusted over a very wide range in terms of the solidification behavior, the curing behavior, and the viscosity. Furthermore, it has been found that the embedding or molding compositions formed from the dry mix according to the invention make it possible to achieve very smooth surfaces, so that finishing work on a casting is minimized.

The composition of the invention can in principle be used in all mold casting processes in which a lost pattern is employed, and in particular in the lost wax process using molds made of half shells. If the mold box is sufficiently strong, a pressure casting process may suitably be carried out under moderate pressure as a result of the high strength of the cured molding composition. In mold casting processes in which a molding is cast in a mold having two mold halves and is subsequently taken out by moving the two mold halves apart, the high stability and strength of the cured molding composition also make it possible to use the mold a number of times in succession, in particular for the production of short series. According to the invention, the materials properties of the molding can also be influenced by presetting the thermal conductivity of the molding composition of the invention, so that the cooling rates of the metal introduced are adjustable and, in particular, significantly higher than in the case of known molding compositions.

The sulfate-carrier-free binder used according to the invention is, for example, ground portland cement clinker. Portland cement clinker is the material which leaves the rotary cement furnace. This material obtained from the furnace is usually milled together with sulfate carriers such as gypsum or anhydrite or mixtures thereof to give portland cement, subsequently screened and then, if desired, packed. The sulfate-carrier-free hydraulic binder used according to the invention is a milled portland cement clinker without addition of sulfate carrier. In the case of the cements customarily produced, the addition of sulfate carrier has the function of regulating curing by formation of the mineral ettringite on the surface of the tricalcium aluminate (C3A).

In particular, it is also possible to use combinations of ground portland cement clinker and/or latently hydraulic materials such as ground slag sand and/or pozzolanic materials such as trass and also microsilica, meta-kaolinite, untreated or heat-treated zeolites, and/or inert, finely milled rock flours such as ground limestone and/or hydraulic limes and/or calcium silicates and/or calcium aluminates or any combination of these constituents. The fineness of the ground clinkers used or the binder constituents used ranges from normal cement fineness to superfine. To regulate the early strength, the solidification behavior and the final strength, the binder component can also be composed of fractions having different finenesses. In addition, the abovementioned individual constituents of the binder component can also each have a different fineness.

The binder component preferably has the fineness of superfine cement. Superfine cements are very finely particulate hydraulic binders, in particular ones having uniform and narrow particle size distributions and a limiting of the maximum particle size. The properties and the customary use of superfine cements is, for example, described in a provisional procedure for injection work using superfine binders in loose rock (Bautechnik 70, [1993], number 9, Ernst & Sohn, pages 550 to 560, and ZTV-RISS 93, Verkehrsblatt-Dokument B 5237, Verkehrsblatt-Verlag).

The constituents of the mixture are preferably matched very precisely and reproducibly to one another, with all significant constituents preferably having a particle size distribution d₉₅≦24 μm, more preferably d₉₅≦16 μm, and d₅₀≦7 μm, more preferably d₅₀≦5 μm, and preferably having a ratio of d₅₀ to d₉₅=0.33±0.04 (d₉₅=particle diameter at 95% by weight passing the sieve; d₅₀=particulate diameter at 50% by weight passing the sieve). In particular, it is possible to optimize the influence of an additive when these conditions are adhered to.

The particulate size distribution of the dry mix is advantageously set in accordance with a modified Gaudin-Schumann function, also know as the Dinger-Funk function (Funk, James G.; Dinger, Dennis R.; Predictive process control of crowded particulate suspensions; Cluver Academic Publishers Group, Distribution Center 3300AH Dordrecht, The Netherlands). In the Dinger-Funk function, and exponent n<0.2 is set, with negative values also being possible. This makes it possible to produce a cured mass having a microstructure of maximum density.

The function is:

$$F ( d ) = \frac{{D}^{n} - {D}_{s}^{n}}{{D}_{L}^{n} - {D}_{s}^{n}}$$

where

D=particle size

Dₛ=minimum particle size

D_{L}=maximum particle size

n=distribution modulus.

According to the invention, the binder mixture or the embedding or molding composition has, for example, both a sulfate-carrier-free binder component and a sulfonate-free fluidizer as additive. The sulfonate-free fluidizer, in particular a polycarboxylate, acts within a short period of time, for example from 2 to 10 minutes, to delay the early setting of the sulfate-free binder component. This is attributed to the sulfonate-free fluidizer, in particular a polycarboxylate, obviously hindering temporarily undesired crystal growth.

The modifying polycarboxylates used are described, for example in DE 196 53 524 A1. These are usually homopolymers or copolymers of carboxyl-containing monomers whose side chains have been modified. Further suitable sulfonate-free fluidizers are materials selected from the group consisting of polyaspartic acids and/or polyacrylates.

In addition, the binder composition may, if desired, further comprise accelerators. Suitable accelerators are, for example, alkali metal carbonates or alkali metal bicarbonates and also calcium nitrate, alkaline metal silicates, alkaline metal hydroxides, alkaline earth metal hydroxidesm, chlorides of polyvalent cations (e.g. calcium chloride), amine compounds and calcium formate and other known accelerators and, of course, mixtures of the accelerators mentioned.

The accelerators are used particularly when a large amount of polycarboxylate is added to achieve a required degree of fluidization at a low water/binder ratio. The accelerators can counter the inhibition, particularly when this goes beyond a desired degree.

The sulfate-carrier-free fluidizer, in particular polycarboxylate, is added, in particular, in amounts of from 0.25 to 2% by mass, based on the binder. In this way, it is possible to achieve, for example, delays of from 2 to 10 minutes combined with very good fluidization. As a result of the strong fluidizing action, the amount of water added and thus the porosity of the binder slurry or the cured binder solid can be reduced, resulting in an increase in strength.

The components of the binder mix, i.e. the binder component, the sulfate-free fluidizer(s) and, if applicable, accelerators and further known auxiliaries and/or additives such as antifoams or aggregates, can, if they are present in the dry state, be premixed to give a factory dry mix which just has to be made up with water prior to production of the casting mold.

Furthermore, stabilizers can also be used in the binder mix.

According to the invention, stabilizers from the group consisting of microbial polysaccharides are used. These are synthetic biopolymers of which xanthan and welan are particularly useful for the purposes of the invention.

Particularly suitable biopolymers are, for example, described in a Velco brochure “Xanthan Gum”, pages 1 to 24, and in particular on page 1, column headed “Microbial polysaccharides”. These are dextran, gellan gum, rhamsan gum, welan gum and xanthan gum.

In addition, the use of a sulfate-carrier-free binder results in the suspension being chromate-free because the chromium component in the superfine ground clinker is bound by hydrate phases. In this respect, there is a synergistic effect.

Furthermore, additive combinations of the additives mentioned above and below can also be advantageously used.

A hydraulic binder composition according to the invention can in this way be precisely preformulated in a simple manner, e.g. at the factory, in terms of its processability, the commencement of solidification, the early strength, the final strength and the durability of the final strength so as to meet the requirements in a particular case.

The binder composition can, alternatively or in addition, comprise a setting inhibitor, if appropriate a plasticizing setting inhibitor.

According to the invention, alkali metal gluconates are used in combination with alkali metal carbonates and/or alkali metal bicarbonates to achieve sensitive control of the setting behavior. Furthermore, the customary plasticizing sulfonate-containing setting inhibitors, in particular, are used as additives. These are, for example, lignin sulfonates, sulfonate soaps, sulfonic acids, alkylbenzenesulfonates, naphthalenesulfonates and sulfonated melamineformaldehyde condensates. However, these can also be replaced, in particular partly, by other sulfonate-free inhibitors. Examples of substances which can be used in part are: cellulose ethers (methyl, ethyl and/or proyl ethers), monosaccharides and/or polysaccharides (fructose, glucose), acrylic acids and their salts, oxycarboxylic acids and their salts (e.g. citric acid), phosphoric acid and their salts, boric acid and its salts, alkylamides, styrene-butadiene.

In particular, the use of polycarboxylates together with sulfonate-containing inhibitors known per se which simultaneously also act as fluidizers in combination with accelerators known per se results in the sulfonate-containing agents being effective only in an inhibiting fashion and not influencing the fluidizing action of the polycarboxylates. The sulfonate-containing fluidizers can be added without adhering to the very precise limiting values, because it is sufficient to add at least that amount required to inhibit a predetermined amount of binder. Larger amounts interfere with neither the inhibition process nor the fluidizing action of the polycarboxylates.

Furthermore, the use of the abovementioned additive combination not only makes it possible to achieve very precise control of the above-mentioned properties but also ensures that exceptionally high early strengths and durable, relatively high final strengths can be achieved. A sticky rubber-like consistency which interferes with use surprisingly no longer occurs despite the presence of sulfonate-containing inhibitors and customary accelerators.

Of course, the use of further additives which do not adversely affect the control of the abovementioned properties and serve to produce other property influences, for example milling aids, is possible within the scope of the invention.

The further control of the abovementioned properties by means of particular particle size fractions and/or particle size ranges can, for example, be carried out using the following ground clinker fractions from streamed superfine material:

d₉₅≦6.5 μm

d₉₅≦9 μm

d₉₅≦16 μm

d₉₅≦24 μm or

any mixtures of selective superfine materials.

In addition, the use of superfine fractions enables additives to be saved or the processability, the early strength and/or the final strength to be controlled, e.g. be improved. The use of particular particle size fractions or particle size ranges also enables additives to be saved in other hydraulic binder compositions and, in the case of particular amounts and type of additives, the processability, the early strength and/or the final strength to be controlled.

The fluidizer can be added in the factory to a factory dry mix and thus be present in the binder mix when it leaves the factory.

Furthermore, lignin sulfonates in combination with alkali metal carbonates can also be used for regulating solidification and curing. As alkali metal carbonates, sodium and potassium carbonates are used in any mixing ratios depending on the objectives.

It has surprisingly been found that variation of the ratio of potassium carbonate to sodium carbonate enables the early strength of the binder paste, i.e. the embedding composition, to be varied within a wide range. The strength development of the made-up binder mix can thus be set in a targeted manner in the factory by means of an appropriate mixture of sodium and potassium carbonates, with the strength development being able to be controlled, in particular in the range from 2 to 24 hours, by the ratio of the alkali metal carbonates. Here, the early strength development and the early strength are controlled for a given mix or a given binder component and in a given range of the early strength by keeping the Na₂O equivalent, matched to these parameters, constant and only altering the ratio of K₂CO₃/(K₂CO₃+Na₂CO₃) within the constant Na₂O equivalent. In addition, the process time can be adjusted within limited time windows at early points in time without lasting strength reductions by means of further additives such as lignin sulfonate. In this way, a wide variability in respect of the commencement of strength and the level of the strength of the paste is obtained. A further possible way of influencing the strength development and the commencement of strength development is via the fineness of the binder component used. Furthermore, these parameters can also be controlled by mixing together different particle size fractions of the binder constituent, in this case the ground clinker, in each case individualized for the particular application.

As additives or aggregates which can be added to the sulfate-carrier-free hydraulic binder are quartz sand (particle size up to 2 mm), ground chamotte, ground sillimanite, ground kyanite, metakaolinite and ground slag, with these constituents being added either individually or as a mixture to the binder in a ratio of from 1:1 to 1:3. The heat stabilities can be increased significantly by means of, in particular, chamotte, sillimanite, kyanite and metakaolinite.

According to the invention, the thermal conductivity of the composition can be adjusted. It is known that the cooling rate of the metallic workpiece has an influence on its crystalline structure and thus on the materials properties. The invention enables the materials properties to be influenced in a targeted manner via the controllable, presettable thermal conductivity of the embedding composition.

The thermal conductivity can be adjusted via the particle size distribution of the dry mix and the porosity or packing density which can be controlled thereby. This can be achieved when, in particular, the above-mentioned particle size distribution corresponds to a Dinger-Funk function and the exponent n in the distribution function is set, for example, to n<0.2 and is in particular negative in order to produce a very high packing density and thus thermal conductivity. The porosity set is <10%.

According to the invention, the thermal conductivity can alternatively or additionally be influenced by the type of aggregates added to the composition. To control the thermal conductivity in this fashion, the aggregates such as quartz or sand or other residual minerals are wholly or party replaced by inorganic solids having a substantially higher specific thermal conductivity. Materials used for this purpose are, in particular, silicon nitride, silicon carbide, nitrides, garnets, sintered alumina and feldspars.

In addition, the composition can further comprise metals, in particular in the form of iron inserts in rod or bar form to aid cooling, metallic fibers and/or granulated metals and/or metal dusts, to increase the thermal conductivity. Appropriately classified metal scrap can also be used for this purpose. For this purpose, a model is preferably firstly encased in a layer of a composition according to the invention with inorganic aggregates and a composition comprising granulated metal or metal dust is subsequently applied. This prevents possible reaction of the cast metal with the metal in the composition, if such a reaction is to be expected. In addition to an embedding composition with metallic aggregates, iron inserts to aid cooling of the type known per se can also be introduced into the composition. These iron inserts to aid cooling are pieces of metal in rod or bar form which are embedded in the composition and, owing to their high thermal conductivity, can readily take up the heat from the casting. Such iron inserts to aid cooling can also be used in a composition containing exclusively inorganic aggregates.

The compositions according to the invention which comprise inorganic aggregates and make possible a high thermal conductivity make it possible to set thermal conductivities significantly above 0.006 J·s⁻¹·K⁻¹.

To influence the thermal conductivity further and/or to influence the contact between molding composition and metal, the mixture can further comprise carbon in the form of carbon black and/or graphite. In this way, the wettability of the surface of the mold by metal can be influenced and in particular reduced. Furthermore, reactive substances which react endothermically when the metal is poured in and thereby additionally withdrawn heat from the system can also be present in the composition. Examples of such reactive substances are mixtures of calcium carbonate and metakaolinite or calcium carbonate and microsilica.

As a result of the compositions of the invention solidifying and curing hydraulically in a concrete-like manner, they are fully water-resistant. As a result, the mold can, according to the invention, be filled with water both from the outside and also through channels. The channels can, in particular in the case of relatively large moldings, likewise be formed by molding wax or the like and be appropriately installed in the mold box. When the model is melted out and/or burned out, the models of the channels are then likewise melted out or burned out. Water can subsequently be passes through these channels with the aid of appropriate connections which may be present on the mold box.

The structure of the cast metal can be influenced in a targeted manner by the above-described, novel influencing of the thermal conductivity. Since castings are produced in metal molds in long production runs, they have a different structure and different materials properties compared to prototypes or parts produced in small runs, which have been produced in plaster of Paris molds or other known molds. The use of the compositions according to the invention also enables short production runs or prototypes to be produced in such a way that the materials properties of the moldings come very close to those of moldings produced in long production runs. This makes it possible for the first time to estimate the suitability of a component cast in a lost wax process considerably more readily from the prototype, since the prototype virtually corresponds to the part produced in a long production run.

It has been discovered, according to the invention, that it is particularly advantageous to add burnout materials which after thermal treatment, in particular after burnout of the wax, are likewise burned out and leave behind specific pores or channels in the cured composition to the binder mix according to the invention for an embedding or molding composition. This is important to conduct away the hydrogen or other gases dissolved in the metal via the channels into the composition and thus obtain a void-free casting. Particularly useful burnout materials are polypropylene fibers (3 to 20 mm long), dolomite fibers, polymer fibers which burn out at temperatures up to about 200° C. in general, and cellulose fibers and wood shavings or wood flour. Furthermore, it has been found to be advantageous to add blood and bone meal or bone meal, since the fats and tissue fibers present are likewise excellent at generating pores and channels on burning out. In addition, the phosphate which remains increases the fire resistance to a considerable degree.

In the case of the sulfate-carrier-free binder used according to the invention, solidification and curing are regulated very sensitively and within wide ranges by the addition of the additives mentioned in place of the sulfate carrier. In the literature, binders of this type are described as inorganic systems comprising ground clinker having very high specific surface areas, fluidizers and alkali metal salts. The fluidizing effect of the additives which is observed appears to be related to their ability to disperse the clinker particles effectively in an aqueous suspension. Since these binders do not contain any sulfate carrier, ettringite (a sulfoaluminate having 32 water molecules) is not formed on the surface of the tricalcium aluminate but instead lower-water-content calcium carboaluminates are formed as earliest hydrate phases.

The novel embedding or molding composition based on sulfate-carrier-free portland cement withstands the influence of elevated and high temperatures better than does the mortar made of conventional portland cement. It's resistant to high temperatures and thermal shock corresponds to that of a mortar comprising alumina cement, which is in any case the typical cement for the refractories industry, but the compositions of the invention have a considerably greater long-term stability. In addition, combinations with microsilica which further improves the resistance to high temperatures are also possible. The properties of the contact zone between the aggregate and the sulfate-free binder have been examined. The contact zone has been found to be very compact and ensured a high bond strength to the matrix. The bond between aggregate and sulfate-free binder in the embedding or molding composition of the invention is twice as high as the corresponding bond strength of the aggregate with portland cement.

While gypsum-bound embedding compositions are preheated prior to melting out the wax, e.g. using temperature increases of from 40 to 60° C. per hour, depending on the size of the mold, with differing residence times (2 hours at temperatures up to 300° C., 4 hours at temperatures of about 700° C.), this is not necessary in the case of the novel embedding or molding compositions based on the sulfate-free binders used according to the invention. The preheating is related to the high bound and unbound water content of the gypsum-based compositions, which leads to crack formation on rapid heating. The mixing ratio for gypsum-bound embedding compositions is 100 parts of powder to 38-40 parts of water. The processing time of the gypsum-bound embedding compositions is from about 10 to 12 minutes.

A mold produced from the embedding or molding composition of the invention does not have to be preheated prior to melting out the wax. The embedding or molding compositions comprising a sulfate-carrier-free binder are produced with a low water/cement ratio. Because no ettringite is formed, these systems are low in water. The mixing ratios when using the binder mix of the invention are molding composition water=100:10 to 100:25. The embedding or molding composition of the invention flows rapidly and easily into the mold, with the products produced from this composition surprisingly having a pore-free surface which is considerably smoother than that of a plaster of Paris composition used in a comparable fashion. The processing time of the compositions of the invention is, for example, from 30 to 40 minutes at 20°, but can be controlled very sensitively and over a very wide range of from a few minutes to a number of hours for each particular application. The composition gives strengths which are many times the strength of known molding compositions.

The embedding or molding composition of the invention can advantageously be employed in many die casting processes. In particular, the composition of the invention can be employed in the lost wax process, especially in the production of individual castings or of short production runs for the production of prototypes. However, the invention can also be advantageously applied to all other die casting processes involving a lost pattern. Embedding or molding compositions of this invention are suitable for casting any metals, including in particular magnesium, in contrast to compositions formed of gypsum plaster, which are not suitable for casting magnesium. However, the high strength of the compositions of the invention after curing makes it possible to produce molds which comprise mold halves which can be brought together and moved apart and in which short runs can be produced, since, due to the high strength, the molds are not destroyed by production of just one casting. Furthermore, if the mold box is designed appropriately, it is also possible to produce castings with application of moderate pressure.

It has been found that the compositions of the invention are also very useful in the refractories sector as binders, fire-resistant mortar and concrete and as repair and tamping compositions, in particular those subject to alkaline attack.

In the case of the mix according to the invention or the molding compositions produced therefrom, it is advantageous that rapid working is made possible by the adjustable processing time. Furthermore, another great advantage over gypsum plaster molds is that a drying time for the cured molding composition can be dispensed with. Furthermore, molding compositions according to the invention give a mold which has a very high strength, in particular compared to gypsum plaster molds. After curing, the molding compositions of the invention are resistant to high temperatures, resistant to thermal shock and have an adjustable thermal conductivity. A particular advantage over other mold materials is the ready disposability, since the mold material raises no environmental concerns and in this respect corresponds to building rubble. Furthermore, the mold material can, even when it contains granulated iron to increase the thermal conductivity, be taken back by the manufacturer and be reused in a simple manner in the cement production process. In addition, it has been found that the molding compositions can be removed easily and in particular considerably more readily than gypsum plaster from the molding by sand blasting.

While this invention has been disclosed in terms of certain embodiments thereof, it is not intended to be so limited, but rather only to the extent set forth in the claims that follow.

1. An embedding or molding composition dry mix for producing embedding or molding compositions for metal casting processes such as the lost wax process, comprising a hydraulic binder component, characterized in that the binder component comprises sulfate-carrier-free ground portland clinker as hydraulic binder.

2. A dry mix as claimed in claim 1, characterized in that the binder component further comprises latently hydraulic and/or pozzolanic binders such as ground slag sand and/or ground trass.

3. A dry mix as claimed in claim 1 or 2, characterized in that the binder component of the binder mix has normal cement fineness.

4. A dry mix as claimed in claim 1 or 2, characterized in that the binder component of the binder mix is very finely milled and has a fineness corresponding to superfine cement.

5. A dry mix as claimed in any of the preceding claims, characterized in that quartz sand and/or ground chamotte and/or ground sillimanite and/or ground kyanite and/or metakaolinite and/or zeolites and/or inert, finely milled rock flours and/or hydraulic material such as calcium silicates and/or calcium aluminates and/or hydraulic limes are added as additives or aggregates to the sulfate-carrier-free hydraulic binder.

6. A dry mix as claimed in any of the preceding claims, characterized in that silicon nitride, silicon carbide, nitrides, garnets, sintered alumina, feldspars or other inorganic solids having a high thermal conductivity are present as aggregates in the embedding or molding composition to influence the thermal conductivity.

7. A dry mix as claimed in any of the preceding claims, characterized in that metal particles and/or granulated metals and/or metal powders and present to influence the thermal conductivity.

8. A dry mix as claimed in any of the preceding claims, characterized in that the additives or aggregates are present in the binder mix in a ratio of from 1:1 to 1:3.

9. A dry mix as claimed in any of the preceding claims, characterized in that burnout materials are present.

10. A dry mix as claimed in claim 9, characterized in that polypropylene fibers, dolomite fibers, polymer fibers, cellulose fibers, wood flour, granulated polymers, blood and bone meal, bone meal or other burnout materials which produce pores and channels in the cured binder mix on being burned out are present as burnout materials.

11. A dry mix as claimed in any of the preceding claims, characterized in that carbon in the form of finely divided carbon black and/or graphite is present to reduce the wettability.

12. A dry mix as claimed in any of the preceding claims, characterized in that curing accelerators and/or setting inhibitors and/or fluidizers and/or stabilizers are present as additives.

13. A dry mix as claimed in claim 12, characterized in that sulfonate-free and/or sulfonate-containing fluidizers are present as fluidizers.

14. A dry mix as claimed in claim 13, characterized in that materials selected from the group consisting of polyaspartic acids and polyacrylates and modified polycarboxylates, where the modified polycarboxylates are homopolymers or copolymers of carboxyl-containing monomers whose side chains are modified, are present as sulfonate-free fluidizers.

15. A dry mix as claimed in claim 14, characterized in that the molar mass of the polycarboxylates is from 5000 to 50000 g/mol and the sulfonate-free fluidizer is, in particular, present in amounts of from 0.25 to 2 mol %, based on the binder component.

16. A dry mix as claimed in claim 13, characterized in that lignin sulfonates, sulfonate soaps, sulfonic acids and further known sulfonate-containing fluidizers are present as sulfate-containing-fluidizers.

17. A dry mix as claimed in claim 16, characterized in that fluidizers having an inhibiting effect on setting are present as sulfate-containing-fluidizers.

18. A dry mix as claimed in any of the preceding claims, characterized in that curing accelerators and/or setting accelerators are present.

19. A dry mix as claimed in claim 18, characterized in that alkali metal carbonates and/or calcium nitrate and/or alkali metal silicates and/or alkali metal hydroxides and/or alkaline earth metal hydroxides and/or chlorides of polyvalent cations and/or amine compounds and/or calcium formate and/or other known accelerators or mixtures of these accelerators are present as accelerators.

20. Dry mix as claimed in claim 12, characterized in that a stabilizer from the group consisting of microbial polysaccharides is present.

21. A dry mix as claimed in claim 20, characterized in that a synthetic biopolymer such as xanthan or welan is present as microbial polysaccharide.

22. A dry mix as claimed in any of the preceding claims, characterized in that the setting inhibitors are present and the setting inhibitors present are cellulose, ethers and/or monosaccharides and/or polysaccharides and/or acrylic acid and its salts and/or oxycarboxylic acids and their salts and/or phosphoric acid and its salts and/or boric acid and its salts and/or alkylamide and/or a styrene-butadiene.

23. A dry mix as claimed in any of the preceding claims, characterized in that alkali metal gluconates and/or lignin sulfonate in combination with alkali metal carbonates and/or alkali metal bicarbonates are present to regulate setting and curing, where sodium and potassium carbonates are present in any mixing ratios as alkali metal carbonates.

24. A dry mix as claimed in any of the preceding claims, characterized in that the components of the binder mix have been premixed in the dry state in the factory to give a factory dry mix.

25. A dry mix as claimed in any of the preceding claims, characterized in that the binder component is composed of fractions of differing particle size or particle fineness to match it to a desired early strength and/or final strength and/or hydration rate.

26. A dry mix as claimed in any of the preceding claims, characterized in that all components of the binder mix are present in differing particle finenesses to give a uniform and gradated particle size distribution matched to a desired early strength and/or final strength and/or hydration rate and/or reaction rate.

27. A dry mix as claimed in any of the preceding claims, characterized in that the particle size distribution of the dry mix matches the particle size distribution of the Dinger and Funk function
$$F ( d ) = \frac{{D}^{n} - {D}_{s}^{n}}{{D}_{L}^{n} - {D}_{s}^{n}}$$
where the exponent n is less than 0.2 and is in particular negative.

28. A dry mix as claimed in any of the preceding claims, characterized in that the particle size distribution is selected so that an embedding or molding composition having a microstructure of maximum density is obtained.

29. An embedding or molding composition using a binder mix as claimed in any of claims 1 to 28 and water.

30. An embedding or molding composition as claimed in claim 29, characterized in that the water/binder ratio after mixing with water is from 0.3 to 0.8.

31. A casting mold for metal casting comprising a cured embedding or molding composition as claimed in claim 29 or 30.

32. A casting produced in a mold as claimed in claim 31.

33. Use of an embedding or molding composition as claimed in claim 29 or 30 as refractory cement, refractory mortar, refractory concrete, refractory repair, spraying or tamping composition.
